(19) United States
(12) Patent Application Publication
(10) Pub. No.: US 2014/0154402 A1
(43) Pub. Date: Jun. 5, 2014

(54) PRODUCTION OF POLYCRYSTALLINE SILICON BY NATURAL SINTERING FOR PHOTOVOLTAIC APPLICATIONS

(71) Applicants: Jean-Marie Lebrun, Iffendic (FR); Jean-Michel Missiaen, Saint Martin D'Heres (FR); Celine Pascal, Saint Martin D'uriage (FR); Jean-Paul Garandet, Le Bourget Du Lac (FR); Florence Servant, Vaulvaneys Le Haut (FR)

(72) Inventors: Jean-Marie Lebrun, Iffendic (FR); Jean-Michel Missiaen, Saint Martin D'Heres (FR); Celine Pascal, Saint Martin D'uriage (FR); Jean-Paul Garandet, Le Bourget Du Lac (FR); Florence Servant, Vaulvaneys Le Haut (FR)

(73) Assignees: Commissariat A L'energie Atomique ET Aux Energies Alternatives, Paris (FR); Universite Joseph Fourier, Grenoble (FR)

(21) Appl. No.: 13/879,361

(22) PCT Filed: Oct. 14, 2011
(86) PCT No.: PCT/EP11/68007

§ 371 Date: Jun. 24, 2013

(30) Foreign Application Priority Data
Oct. 15, 2010 (FR) 1058441

(51) Int. Cl. C03B 32/00

(52) U.S. Cl. CPC C03B 32/00
USPC 427/9; 118/666; 118/665

(57) ABSTRACT

Silicon sintering method, without applying an external force, comprising placement of a silicon sample in a furnace, then heat treatment of this sample at, at least one temperature and at least one partial pressure of oxidising species to control the thickness of a silicon oxide layer on its surface.

### TECHNICAL FIELD AND PRIOR ART

This invention relates to the fabrication of semiconducting type materials using the natural sintering technique. The method used allows control of the density and porosity of the treated material as a function of the thickness of the oxide layer on its surface.

A method according to the invention makes it possible to use the natural sintering technique to make wafers with dimensions and properties adapted to applications in the electronic and photovoltaic fields and other fields.

Silicon is the main element used for fabrication of electronic and photovoltaic components. High purity silicon (>99.999%) is used to achieve the required properties in these fields. Purified silicon is usually conditioned in the form of ingots. In the previously mentioned fields, silicon is used in the form of a wafer, the thickness of which is of the order of a few tens to a few hundred μm, these dimensions are very much smaller than the width and the length of the wafer (see document FR 2 940 520). The next step is to shape the material by successive cuts. These steps are expensive in time, means and material. The quantity of lost material can be as high as 50%. This represents an additional cost of about 10% to 25% on the global method for the fabrication of a photovoltaic module. Therefore, there would be major benefits in the development of a method for producing polycrystalline silicon wafers without a cutting step.

Powder metallurgy offers an attractive solution. It enables shaping of the material before its densification that is done by heat treatment. Thus, cutting steps are eliminated. Therefore, this fabrication method is flexible, fast and economic.

There are two sintering techniques, namely with or without load. The load consists in applying an external force on a sample during the heat treatment to improve densification. The use of a material in contact with the sample is a risk factor related to contamination and sticking to the sintered material. It is also difficult to apply a force on a sample uniformly and therefore to have a sample with a uniform density. Furthermore, sintering with or without load cannot be used to make sufficiently pure wafers for applications in the electronic and photovoltaic fields.

The second sintering technique called the natural sintering technique, without load or without the application of an external force, cannot be used to achieve high densities for covalent materials. Therefore, it is difficult to obtain high density wafers by natural sintering. This difficulty in densification has been confirmed experimentally in several studies, particularly by C. GRESKOVICH et al. (Sintering of Covalent Solids, Journal of the American Ceramic Society, 59(7-8):336-343, 1976).

Various assumptions have been put forward to explain this difficulty with silicon:

an abnormally high grain boundary energy associated with an abnormally low diffusion coefficient at the grain boundary;

the presence of a very stable layer of “native” silicon oxide, SiO₂, of the order of one nanometer thick, on the particles surface (Carl Wagner, Journal of Applied Physics, volume 29, number 9, September 1958).

There is no general agreement about any of these assumptions at the present time.

Therefore, until now, it has been impossible to obtain wafers with a density of more than 85% that respect the required purity criteria for applications in the photovoltaic field using the natural sintering technique (WO 2004/093202 A1).

Therefore, the problem arises of finding a new natural sintering method to obtain controlled densities.

Moreover, silicon with controlled porosity is required in readiness for specific applications (particularly batteries).

### PRESENTATION OF THE INVENTION

This invention relates to a natural, or without load, sintering method for the production of one or several wafers of covalent materials, for example such as semiconducting materials and particularly silicon or germanium. The following presentation of the invention can be generalised to these various materials.

The invention relates firstly to a load-free silicon sintering method comprising:

positioning of a silicon sample in a furnace;

heat treatment of this sample, initially in granular form or in powder form, at, at least one temperature and at least one partial pressure of one or several oxidising species to control the thickness of at least one silicon oxide layer on the surface of this sample or on the surface of grains;

possibly a measurement of the change in the mass of the sample during the sintering method.

With such a method, the density and/or the porosity and/or the proportion of silicon oxide are controlled.

Considering the work already done, densification by natural sintering of silicon is a priori not attractive. This sintering step is usually done under a neutral or reducing atmosphere. Sintering of metallic powder under this type of atmosphere facilitates elimination of surface oxides that form a “barrier” to sintering according to M. Munir (Z. A. MUNIR. Analytical treatment of the role of surface oxide layers in the sintering of metals. Journal of Materials Science, 14(11):2733-2740, 1979). Surprisingly, the inventor observed a link between the thickness of the oxide layer present during the sintering method at no load, and the densification and porosity level of the materials obtained.

The invention enables to control the formation and/or partial or total elimination of the oxide layer on the sample surface during the sintering method in order to obtain a material with controlled density and porosity.

The thickness of the oxide layer can also be calculated as a function of measurements of the change in the mass of the material and/or calculated from a simple kinetic model.

A method according to the invention may be preceded by a shaping step, for example by compression of the sample or the material. In particular, the unfinished (or raw) part (or preformed part) may be derived from shaping using a wide variety of methods such as cold or hot uniaxial or isostatic compression. One of the shaping methods making use of the Metal Injection Moulding technique (see FR 2 931 297) could also be suitable. For example, high pressure is applied to favour high density, and low pressure is applied to favour the porosity of the sample or compressed pellet.

The thickness of the sample along at least one direction before the sintering method may be less than a few millimetres, and preferably less than one millimetre. The sample will be as thin as possible along at least one dimension so as to limit any gradient phenomena during diffusion of gas outside and/or inside the compressed pellet.

Powders may have a small equivalent diameter, for example less than 500 nm, and for example between 300 nm and 100 nm. Powders are then obtained for example by decomposition of precursor gases such as silane. Small diameter powder grains may advantageously be shaped in advance with at least one low pressure, typically less than 600 MPa in order to prevent any blockage of the preform production system.

These small diameter powders have a high specific surface area (>5 m²/g), and possibly a quantity of oxide on their surface. For a given oxide thickness, a powder with a large specific surface area has a larger quantity of silica than a powder with a smaller specific surface area. Thus for equal quantities of treated silicon, the oxide is kept at a higher temperature throughout the sintering method, improving densification.

Powders with a diameter of more than 500 nm can be obtained using conventional grinding techniques. Prior shaping will advantageously be done with at least one high pressure, typically greater than or equal to 900 MPa for these larger diameter grains, for example between 500 μm and 5 μm. This or these high pressures can result in a sample with sufficient mechanical strength to keep its shape. Larger diameter powder grains may be preferred to obtain material with large grains, and therefore fewer defects so that the life time of carriers is greater than the time necessary to collect them. It is possible to have intermediate size grains, for example between 5 μm and 500 nm, which are shaped in advance with the same high pressures. Powders may comprise a native oxide thickness between 50 nm and zero, and preferably between 3 nm and 0.

The sample may be composed of a powder mix comprising different size grains to facilitate the growth of grains and densification of the mix. Fine powders that have a higher specific surface area facilitate the densification phenomenon during the sintering method. The grain growth phenomenon is improved by the presence of grains with a wide dispersion of sizes. The presence of large grains is a characteristic required for photovoltaic applications. A method according to the invention can be used to control the densification of the sample and/or the size of sample grains regardless of size grading of the powder used.

According to the invention, the atmosphere that surrounds the sample comprises one or several oxidising species, in other words a species with composition ROₙ where n is a positive number and R is a chemical element. The atmosphere may be composed of a neutral vector gas and one or several species that are capable of oxidising the material, for example of the O₂ and/or H₂O, and/or CO, and/or preferably SiO type.

The pressure (or the oxidising partial pressure) and/or the flow of oxidising species and/or the temperature may vary or remain constant throughout the sintering method to control the thickness of the oxide layer on the sample or of the material.

The thickness of the oxide layer may be controlled so as to obtain a required density and/or an oxygen content and/or a silica content in the material. This thickness may be uniform or non-uniform at the scale of the sample or the compressed pellet being treated, and/or at the scale of the powder forming it before sintering.

The size of the pores in the sample can also be controlled after the oxide layer has been eliminated as a function of the heat treatment.

One embodiment of the invention comprises one or several stages during the heat treatment in order to control enlarging of the grains size and the pores size of the sample.

The shrinkage of the sample may also be measured and the volume change may possibly be calculated from this measurement during the sintering method according to the invention.

The material density may also be calculated from the measurements and/or calculations of the mass and shrinkage of the material.

The temperature rise rate and/or the flow of the oxidising species may be chosen so as to control the etching rate of the oxide layer. Oxidation of silicon can thus be limited or encouraged throughout the sintering method according to the invention.

After treatment according to one of the previous sintering methods, the sample is thick enough along at least one direction so that it can be handled. At least one dimension of the compressed pellet may be more than 10 or 50 μm thick, or between 100 and 500 μm thick, and preferably equal to about 300 μm.

The invention also relates to a load-free sintering device, preferably for silicon, that comprises:

a furnace,

means of controlling the temperature of the furnace chamber,

means of controlling the oxidising partial pressure in the furnace chamber,

means of controlling the temperature and oxidising partial pressure control means in the furnace so as to control the thickness of the oxide layer on the silicon.

The device may also comprise means of measuring the change in the mass of the sample throughout the heat treatment.

The device may also comprise means of measuring the shrinkage of a silicon sample by contact (for example using a feeler) or remotely (for example using optical means).

According to one embodiment of the device, a set of valves connected to a neutral vector gas (for example helium or argon) and an oxidizing gas (for example water) is used to control the proportion, flow and pressure of the mix of these gases in the furnace chamber.

One variant of the device according to the invention may comprise means of calculating the thickness of an oxide layer as a function of measurements of the change in the mass of the material and/or a simple kinetic model to calculate the sample mass.

Such a device may also comprise means of calculating the material density from measurements of changes in mass and/or a simple kinetic model to calculate the mass of the sample and material shrinkage measurements.

A device according to the invention may comprise electronic means connected to one or several of the previous elements so as to be able to control one or several parameters of the device. According to one alternative, the electronic means may perform one or several calculations, for example such as the calculation of the thickness of the oxide layer on the material and/or the volume of the sample and/or the density and/or the porosity and/or the proportion of the material and its oxide.

With such a device, an operator may be able to control the entire device through a data display means and a control interface (for example a keyboard) connected to the electronic means.

A product according to the invention comprises or is composed of silicon and remanent silica with controlled proportion and density in order to create localised zones capable of trapping impurities in the material such as oxygen and/or carbon and/or metallic impurities (“getter” effect).

The product is preferably obtained in the form of a wafer more than 50 μm thick so that it can be handled.

### BRIEF DESCRIPTION OF THE DRAWINGS

FIGS. 1A and 1B show diagrams of an example embodiment of a device according to the invention composed of a furnace, sample support means, sample shrinkage measurement means, means of controlling the temperature and the atmosphere in the furnace chamber (FIG. 1B) and possibly means of measuring the sample mass (FIG. 1A).

FIG. 2 shows a diagram of a device according to the invention composed of a feeler in contact with the surface of a sample in the furnace chamber so as to measure its shrinkage.

FIG. 3 shows a diagram of a cross-section of a sample obtained according to the invention.

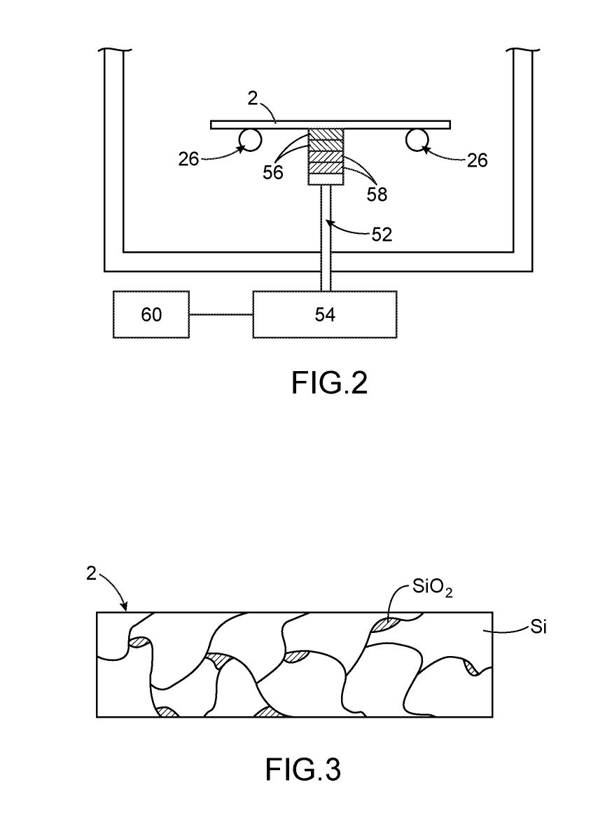

FIG. 4 comprises a transition curve (I) between growth (zone A) and de-growth of the silicon oxide (zone B) as a function of the pressure (in ppm) in oxidising species present in the atmosphere surrounding the sample and the temperature (° C.) of the heat treatment during the sintering method.

FIG. 5 is composed of size grading curves associated with powders with an average diameter (in μm) (M) and a large diameter (G). Measurements are made by laser size grading.

FIG. 6 shows mass loss curves (in mg) of the powder with fine size grading (F) as a function of the temperature (in ° C.) for different examples of the heat treatment rate at a constant flow of two litres per hour.

FIG. 7 is composed of several curves as a function of the powder shrinkage time (in minutes) of powders with grains of fine (F), medium (M) and large (G) diameters, with average sizes equal to 200 nm, 14 μm and 130 μm respectively during a sintering method according to the invention. The powders are preformed in the form of 8 mm diameter and about 7 mm high compressed pellets. The temperature is increased up to 1350° C. at a rate of 1.25° C./min and the controlled water pressure is equal to 80 ppm at a constant flow of two litres per hour.

FIG. 8 shows curves of the oxide thickness (in nm) and the relative density of a sample as a function of time (in min) during a sintering method according to the invention. The temperature is increased up to 1350° C. at a rate of 0.625° C./min, under a constant water partial pressure equal to 80 atomic ppm and at a constant flow of two litres per hour.

### DETAILED PRESENTATION OF EMBODIMENTS

The invention proposes a natural sintering method to control the thickness of the oxide layer on a material during its heat treatment. It is thus possible to control the density or/and porosity of the material.

A device and then an embodiment of a method according to the invention are disclosed below. For reasons of clarity, identical elements on the different figures are denoted with the same numeric references.

An example of a device that could be used in the framework of the invention will now be described.

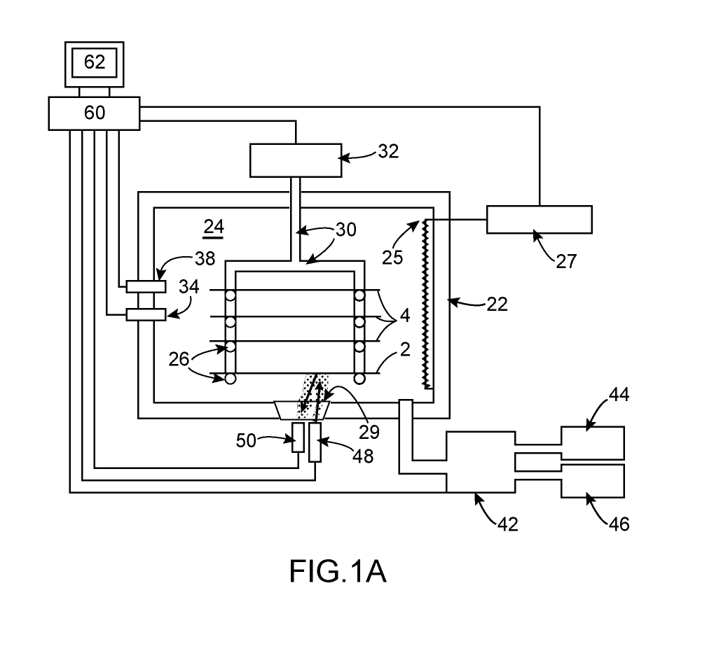

This device comprises a furnace 22 (FIG. 1A) that can be heated, using for example electrical resistances 25 connected to a control box 27. The means 25 and 27 are used to control the temperature in the furnace chamber 24.

Means 42 such as a set of flowmeters are connected to a vector gas source 44 and an oxidising gas source 46, for example water vapour. They are used to control the flow, proportion and pressure of a mix of gases 44 and 46. This mix is then introduced into the furnace chamber 24.

One possible alternative to obtain the gas comprising the oxidising species may consist in making a dry gas bubble in a thermostat-controlled water bath such that the gas mix reaches the required water vapour pressure (a few %). The vector gas flow containing the oxidising species, in this case water, can then be controlled using means 42.

Another alternative might consist in creating a vacuum in the chamber 24. The oxidising partial pressure is then regulated using a micro-leak of oxidising gas, for example air, towards the inside of the chamber.

The temperature and the partial pressure of the oxidising species of the gas surrounding the sample 2 or the samples 2 and 4 are measured respectively by a temperature probe 34 and a probe 38 used to measure the proportion of oxidising species (or partial pressure), for example such as a hygrometric probe. One and/or both probes may or may not be in contact with the sample. The materials forming the probes are chosen to not react with the sample, for example such as tungsten with a silicon sample.

The furnace chamber 24 may comprise one or several supports 26 held in place by a structure 30 (FIG. 1B). The structure 30 may also be suspended from a mass measurement device 32, for example a balance or a thermo-balance (FIG. 1A). “Thermo-balance” means a balance adapted to operate in media at high temperatures, measuring the change in mass of the sample. Supports 26 are designed to support the preformed sample(s) 2 and 4. The structure 30 and the supports 26 are made from a material that does not react with the sample(s). For example, in the case of silicon samples, the chosen metal may be tungsten covered with silicon to prevent any interaction phenomenon.

Shrinkage of the sample may be measured by reflection of a signal emitted by a laser source 48, on a face of the sample 2. The reflected signal is detected by a photosensitive diode 50 connected to an electronic device 60 to calculate shrinkage of the sample. The means 48 and 50 may for example be installed outside the furnace chamber 24. The measurements are made through an opening or a window 29 transparent to the laser wavelength.

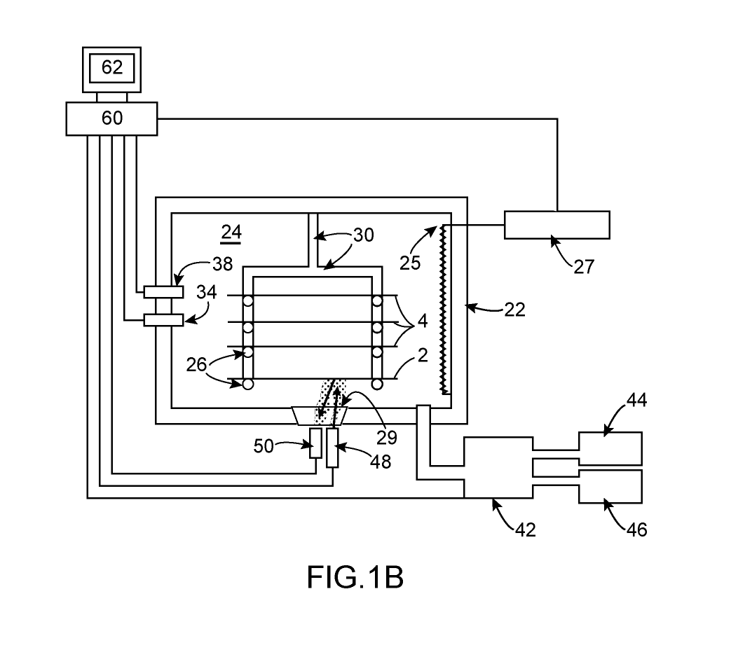

All other devices that are or are not in contact with the sample used to measure the variation in shrinkage of the sample are suitable for fulfilling this aspect of the invention. For example, the shrinkage measurement may be made using a feeler 52 in contact with the sample 2, and that does not react with the sample. Intermediate wafers, for example two wafers made of silicon 56 and alumina 58 may be inserted between an alumina feeler and the surface of the sample 2 (FIG. 2), to prevent any reaction between the feeler and the sintered material. The change in volume is calculated by means 60 using shrinkage measurements made by a case 54 connected to the feeler 52.

The device comprises electronic means 60 such as a computer or a calculator. The control and measurement means 27, 32, 34, 38, 42, 48 and 50 are connected to the electronic means 60. Starting from these informations, the calculation operations are done by means 60. These means may be programmed to implement a sintering method according to the invention. The method parameters such as for example the temperature and/or pressure and/or flow and/or shrinkage and/or change in mass of the sample may be controlled by means 60. Starting from the measurements and the parameters of the sintering method, the means 60 may be used to make calculations such as the mass and/or thickness of the oxide layer and/or density and/or porosity of the sample. A display screen 62 displays the various parameters and calculations in the form of graphs or values in order to control the method. An operator may also use these means and means forming an interaction interface such as a keyboard, to enter regulation set values of the system and/or parameters of the method used, for example a temperature and/or a temperature rise and/or a pressure change and/or an oxidising gas flow.

In one variant of the above device, the experimenter can avoid the use of a thermo-balance by using a simple kinetic model developed by the inventor. In this case the device comprises means described above with reference to FIG. 1A but no longer comprises means 32 as shown in FIG. 1B. This may be simpler to set up and less expensive.

By assuming that thermodynamic equilibrium is always reached and that diffusion does not restrict departure of species, which may be the case for sufficiently thin wafers (<1 mm), the oxide mass can be estimated, for example for silicon and for example for an oxidising species being water, according to the equation (1) given below using means 60:

$${m}_{t + Δ t}^{{SiO}_{2}} = {m}_{t}^{{SiO}_{2}} + \frac{Q}{{RT}_{0}} ( {P}_{t}^{{H}_{2} O} - {P}_{eq}^{{H}_{2} O} - {P}_{eq}^{SiO} ) ( {M}_{O} + \frac{1}{2} {M}_{S} ) \qquad ( 1 )$$

where P^{x}_{eq} and Mₓ are the partial pressure at equilibrium and the molar mass of species x respectively, Q is the carrier gas flow in the chamber, R is the universal gas constant, T₀ is the temperature at the location at which the carrier gas flow is measured and t, Δt are the time and the change in time.

At the same time, the relative density of the sample can be calculated using equation (2) assuming that shrinkage is isotropic:

$${d}_{t + Δ t}^{p} = \frac{{m}_{t + Δ t}^{p}}{{ρ}_{Si} \times {V}_{t}^{p} ( 1 + \frac{{L}_{t + Δ t}^{p} - {L}_{t}^{p}}{{L}_{t}^{p}} )} \qquad ( 2 )$$

where m^{p}_{t+Δt} represents the mass of silica and silicon forming the sample, V^{p}ₜ is the sample volume at instant t and L^{p}ₜ is the measurement of the sample length in one of the three directions in space at instant t, and ρₓ is the density of the species x. Once again, the calculations can be made using means 60.

An example embodiment of a method according to the invention will now be described.

A sample is placed in a furnace as described above. For example, one or several preforms 4 are introduced into the furnace chamber 24 and may be arranged on the supports 26. Only one preform 2 is considered in the remainder of the method for reasons of clarity.

The furnace is heated to a temperature at which sintering is possible, lower than the melting temperature of the material. Means 42 are used to control the partial pressure of the oxidising species (in this case water) so as to facilitate growth or elimination of an oxide layer at the surface of the material.

During sintering, mass loss measurements are obtained using a thermo-balance 32 connected to the structure 30. The shrinkage of the material is measured using means 48, 50.

In the case of silicon, the furnace temperature is increased by means 25 and 27 to reach the very high temperature range between 1 000° C. and the melting temperature, 1 414° C. The rate of temperature increase is 0.625° C. per minute.

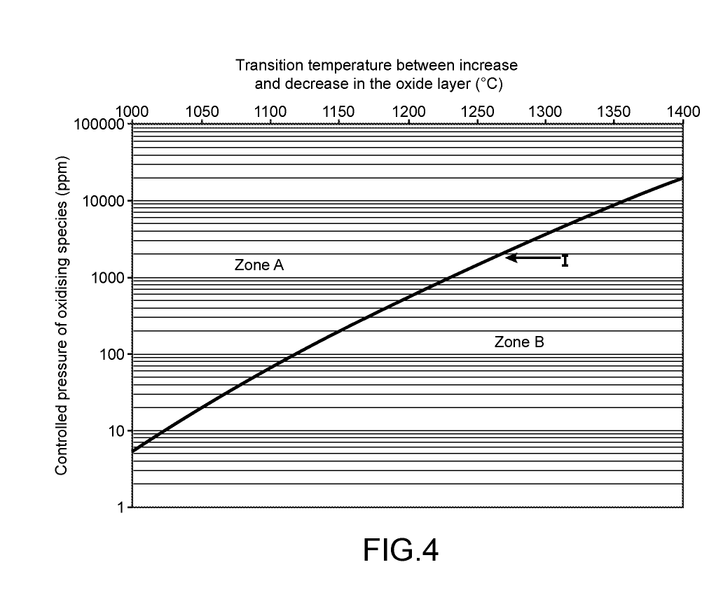

In general, temperature and partial pressure of oxidising species conditions are chosen in advance to facilitate growth or elimination of the oxide from the material, for example using thermodynamic data for this material. FIG. 4 shows such data for silicon, curve I delimits a zone A and a zone B. Zone A corresponds to the passive oxidation phenomenon and the formation of solid silica at the silicon surface. In zone B, the active oxidation phenomenon occurs which means that the silica is reduced by silicon into a gaseous species. During the sintering method, the pressure and temperature conditions are in zone A or zone B, for formation or elimination respectively of an oxide layer.

For temperatures between 400° C. and 1000° C., mass measurements of the sample by means 32 show a growth in its mass. The silicon is passively oxidised by water according to reaction 1:

Si₍ₛ₎+2H₂O_{(g)} [symbol] SiO₂₍ₛ₎+2H_{2(g)}
Reaction 1: Passive oxidation of silicon by water

Above 1 000° C., the inventor has observed that the sample may lose mass depending on the temperature, flow and pressure of the oxidising gas, but this was not mentioned in the literature.

According to M. Carl Wagner (Journal of Applied Physics, volume 29, number 9, September 1958), active oxidation of silicon is very strongly limited by the presence of a layer of silica at the silicon surface. The silica layer is very impermeable to oxidising species, according to the author. It was then considered that the only way to actively oxidise the silicon is through reaction 2, once the silica layer has been eliminated by another reaction 3 taking place at a higher temperature.

Si₍ₛ₎+H₂O_{(g)} [symbol] SiO_{(g)}+H_{2(g)}
Reaction 2: Active oxidation of silicon by water

SiO₂₍ₛ₎+H_{2(g)} [symbol] SiO_{(g)}+H₂O_{(g)}
Reaction 3: Elimination of oxide according to Wagner, adapted to the case of a hydrogen atmosphere

The inventor demonstrated that silicon is also attacked in the presence of silica on the surface of the silicon according to reaction 4:

Si₍ₛ₎+SiO_{2(g)} [symbol] 2SiO_{(g)}
Reaction 4: Reduction of silica by silicon

The previous reduction and oxidation reactions depend on two parameters: the temperature (so-called transition temperature) and pressure of the oxidising species (so-called transition pressure). It is possible to favour the one or the other by controlling these parameters. These parameters are calculated from thermodynamic data available in the literature (W. Malcolm and Jr. Chase. Nist-janaf thermochemical tables in the Journal of Physical and Chemical Reference Data, volume 9, American Chemical Society, American Institute of Physics, 4th edition, 1998). The curve in FIG. 4 is calculated from these data.

Therefore, formation of the silica layer at the surface of the silicon grains according to reaction 1, and/or elimination of this layer according to reaction 4 can be controlled precisely by moving into zone A or B respectively. In these cases, the reactions involved (reaction 1 or 4) are known. It is then possible to attribute the formation or elimination of elements involved in reactions 1 or 4, to changes in the mass of the sample. The silica mass calculation given below can be used assuming that diffusion does not limit departure of species, to determine the thickness of the oxide layer at the surface of powders. The mass of oxide created or eliminated can be calculated from measurements made by means 32 according to equation (3):

$$\begin{matrix} {si ( \frac{\partial m}{\partial t} )}_{t} > 0 {m}_{t + Δ t}^{{SiO}_{2}} = {m}_{t}^{{SiO}_{2}} + Δ t \times {( \frac{\partial m}{\partial t} )}_{t} \times ( 1 + \frac{{M}_{Si}}{2 {M}_{O}} ) \\ {si ( \frac{\partial m}{\partial t} )}_{t} < 0 {m}_{t + Δ t}^{{SiO}_{2}} = {m}_{t}^{{SiO}_{2}} + Δ t \times [ {( \frac{\partial m}{\partial t} )}_{t} + {P}_{t}^{{H}_{2} O} \times \frac{{QM}_{Si}}{{RT}_{0}} ] \times ( 1 - \frac{{M}_{Si}}{2 ( {M}_{Si} + {M}_{o} )} )\end{matrix} \qquad ( 3 )$$

where Mₓ represents the molar mass of species x, P^{x}ₜ is the partial pressure of species x at instant t, Q symbolises the carrier gas flow in the chamber, R is the universal gas constant and T₀ represents the temperature at the location at which the carrier gas flow is measured.

Starting from the mass calculation, the distribution of the silica quantity at the surface of the silicon grains (the sizes of which are known) can then be calculated according to equation (4):

$${e}_{t + Δ t}^{{SiO}_{2}} = {e}_{t}^{{SiO}_{2}} + \frac{{m}_{t + Δ t}^{{SiO}_{2}} - {m}_{t}^{{SiO}_{2}}}{S . S . \times {m}_{Si} \times {ρ}_{{SiO}_{2}}} \qquad ( 4 )$$

where m^{x}ₜ symbolises the mass of species x at instant t, S.S. is the specific surface area of powders, and ρₓ is the density of species x with mass mₓ.

According to one possible step in the method, the oxide thickness at the silicon surface is calculated by means 60, starting from the mass measurements and equations (1) and (2) or (3) and (4).

Therefore, reactions 1 and 4 can be controlled in time by controlling the rate of temperature rise or fall by means 25, 27 and 34, and the pressure and flow of oxidising species by means 42 and 38. Consequently, it is possible to control the thickness of the silica layer during the sintering method without load and determine its value.

Furthermore, the operator can take account of diffusion of gaseous species (H₂O, SiO . . . ) in the sample or in the chamber, for example by using a finite element model of the part to solve conventional convection-diffusion equations.

Furthermore in his research, the inventor confirmed the assumption by M. William S. Coblenz (Journal of Materials Science 25 (1990) 2754-2764) according to which silica plays a role in the silicon densification phenomenon. M. Coblenz assumes that sintering of silicon in the presence of oxide can inhibit the non-densifying surface diffusion phenomenon, and that a densifying phenomenon will occur instead. With the method according to the invention, the silicon densification phenomenon is controlled by controlling the heat treatment (treatment temperature and rate), and by controlling the oxidising species in contact with the sample (flow and/or pressure). The examples given below of methods according to the invention clearly show that the density of the material obtained is controlled.

A first example embodiment of a method according to the invention uses a silicon powder with purity 5N (>99.999%). The purity of the powder is chosen as a function of criteria associated with the final application (for example the photovoltaic field). Powder F has a BET specific surface area equal to 11.7 m²/g. This corresponds to primary particles of the order of 220 nm with a native oxide thickness equal to 0.46 nm. Particles of about 220 nm are grouped into “collars” that can reach a few micrometers (table I):

TABLE I

| | | | | Selected for the study | | |
|---|---|---|---|---|---|---|
| | | | | Specific | | |
| Pow- | | | | surface | Equivalent | |
| der | Supplier | SEM | | area | diameter | Morphology |
| F | S′tile | # 200 | nm | 11.7 m²/g* | 220 nm* | Spherical |
| M | Alfa | <40 | μm | 0.18 m²/g** | 14 μm** | Sharp |
| | Aesar | | | | | particles |
| | Ref: | | | | | |
| | 35662 | | | | | |
| G | Alfa | # 100-300 | μm | 0.02 m²/g** | 130 μm** | Sharp |
| | Aesar | | | | | particles |
| | Ref: | | | | | |
| | 36212 | | | | | |

*Estimated from measurement of the BET specific surface area
**Estimated from the LASER size grading measurement

In this and the following examples, the techniques applied to characterise the powders used are observation by scanning electron microscopy (SEM), LASER size grading and specific surface area measurements using the Brunauer, Emett and Teller (BET) method. Measurements in the previous table do not take account of oxygen impurities related to the presence of native oxide on the surface of the powders. Therefore, the powder may have a native oxide thickness of between zero and 50 nm, and preferably between 0 and 3 nm.

The powder is preformed by classical methods related to the sintering technique, for example such as methods used in patent FR No 2 934 186. A 8 mm diameter 7 mm high raw cylindrical part is formed by compaction. In this first example embodiment of the method, the raw material has a relative density equal to 53%, table II:

TABLE II

| | | | | Density after |
|---|---|---|---|---|
| | Compacted | Shaping | | sintering |
| Powder | density | pressure | Raw density | 1350° C.-3 h |
| F | 4% ρₜₕ | 50 Mpa | 53% ρₜₕ | 63% ρₜₕ |
| | | Uniaxial shaping | | |
| | | 450 MPa | | |
| | | Isostatic pressure | | |
| M | 27% ρₜₕ | 900 MPa | 63% ρₜₕ | 66% ρₜₕ |
| | | Uniaxial pressure | | |
| G | 34% ρₜₕ | 900 MPa | 73% ρₜₕ | 75% ρₜₕ |
| | | Uniaxial pressure | | |

The compacted density measurements presented in table II are made raw and after sintering for one hour at 1350° C.

For powder F, the preform or raw part is made by applying a low uniaxial pressure equal to 50 MPa. This value is not exceeded so that grains do not slide between the piston and the die that would cause risks of the assembly becoming blocked. Subsequently, a cold isostatic compression is made to reach a raw density of 53%. The global shrinkage for this powder during the sintering step is greater than for larger sized powders because the shrinkage phenomenon is increased with small dimension particles (table III).

A mix between the He—H₂ carrier gas (4%) and H₂O oxidising gas (80 ppm) is used. The gas mix is introduced into the chamber 24 at a rate of 2 litres per hour, adjusted and controlled by means 42 and 38 respectively.

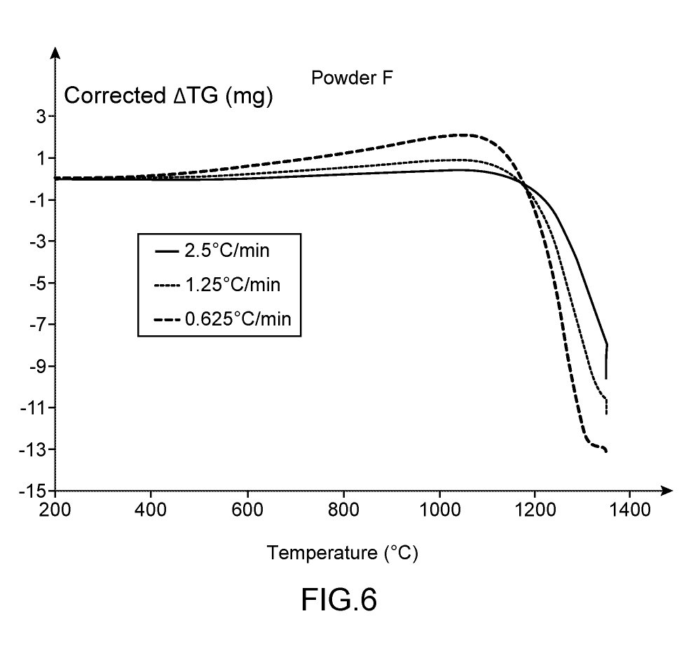

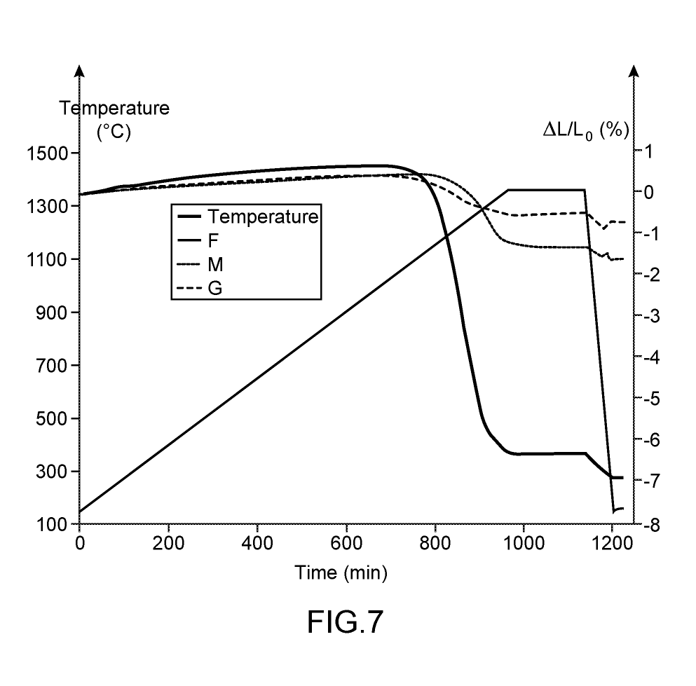

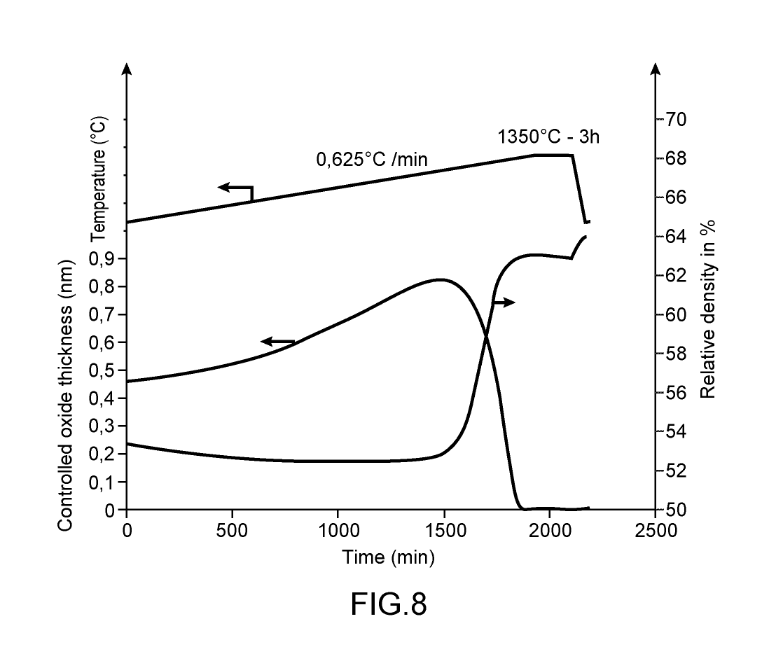

Means 60 calculate the density of the part starting from measurements of the change in mass of the material (FIG. 6) and shrinkage of the sintered material (FIG. 7). These measurements and values are shown in FIG. 8 and can be displayed on the screen 62. The operator can use FIG. 8 to control the thickness of silica at the surface of the powders and the shrinkage in parallel during the sintering method according to the invention.

According to one variant of the previous method, the operator fixes the pressure in oxidising species at 80 ppm and varies the temperature to be in zone B in FIG. 4 during the sintering method to facilitate departure of all the oxide before the powder F compressed pellet reaches a density of more than 63%.

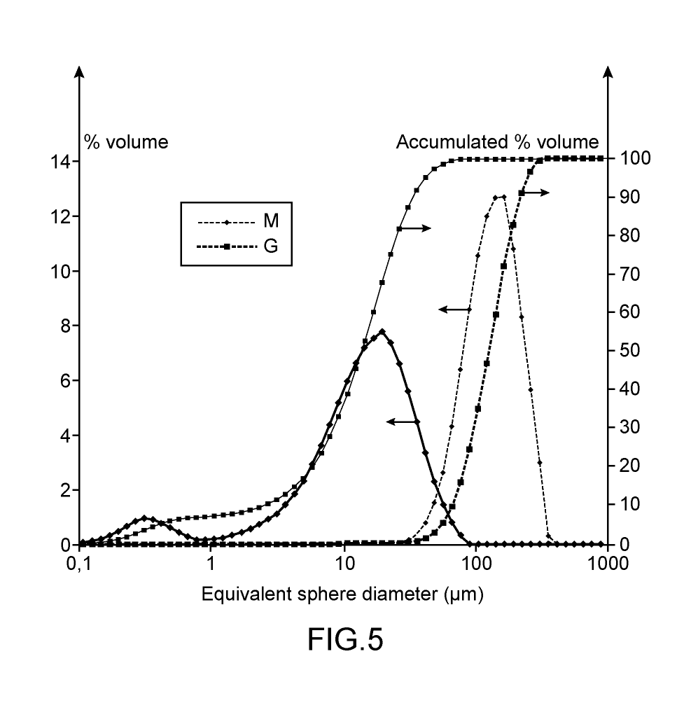

According to another example embodiment of the method, a silicon powder called M with similar purity to powder F is used. Powder M has crystals for which the equivalent diameter is centred around 14 μm (table I). Finer particles are associated with angular crystals for which the equivalent diameter is centred around 300 nm (FIG. 5). These fine particles represent slightly less than 10% of the volume.

Powder M has a very good flowability, partly related to its morphology that is not conducive to the formation of agglomerates. The wafers are shaped without binder by applying a uniaxial stress of at least 900 MPa in order to obtain mechanical strength. The raw density is of the order of 63% before sintering, and increases to 66% after sintering (table II).

A third example embodiment according to the invention uses a silicon powder G, with similar purity to powder F. Powder G has very coarse crystals with an equivalent diameter of between 50 and 300 μm (table I, FIG. 5).

The powder has a very good flowability, partly related to its morphology which is not conducive to the formation of agglomerates. The wafers are shaped without binder by applying a uniaxial stress of more than 900 MPa to give mechanical strength. The raw density is of the order of 73% before sintering, and 75% afterwards (table II).

The following table (table III) shows measurements of thermal expansion, shrinkage and loss of masses as observed and calculated for the F, M and G powders during heat treatment at a rate of 1.25° C./min to reach a plateau at 1350° C.

TABLE III

| | | | Observed | Estimated oxide |
|---|---|---|---|---|
| | Expansion (%) | Global | mass | thickness |
| Powder | 150-1000° C. | shrinkage (%) | loss (%) | (nm) |
| F | 0.65 | 6.9 | 2.7 | 0.5 |
| M | 0.41 | 1.6 | 3.4 | 25 |
| G | 0.41 | 0.7 | 0.9 | 5 |

According to another example embodiment of a method according to the invention, a silicon powder with a BET specific surface area equal to 51.6 m²/g is used. The value of the specific surface area corresponds to primary particles of the order of 50 nm, with a native oxide thickness equal to 0.5 nm. The part formed using the method according to the invention has a relative density equal to 51%.

The partial pressure of water in the gas is always kept constant and equal to 80 ppm. The heat treatment temperature is increased at a rate of 50° C./min. When the chamber reaches a temperature of 1350° C., a majority of the silica remains present in the material. The silicon wafers obtained then have time to densify to 98% before global shrinkage of the silica. Another alternative consists in keeping the rate low by increasing the pressure in oxidising species to achieve the same result.

One of the previous methods may possibly comprise at least one additional step to cover one or several samples, by mixing silicon and silica powders preferably to be equimolar before heat treating said samples. This powder is called the cover powder in the following description, and may partially or completely cover at least one sample. For example, a cover powder volume may comprise several superposed and/or juxtaposed samples separated from each other by said powder.

During the heat treatment of a sample or a compressed pellet, the cover powder releases SiO type oxidising species according to reaction 4. In this way, the pressure in oxidising species surrounding the sample is uniform and is equal to the equilibrium pressure.

Preferably, the thickness of this cover powder on the surface of a compressed pellet is the same or similar along a direction perpendicular to said surface. This is conducive to a uniform distribution of oxidising species around and possibly within a sample.

In this way, the thickness of the silica layer present on silicon grains forming a sample is similar or equal before and during the heat treatment. In other words, as long as the mix of Si—SiO₂ powder surrounds a sample, the oxide thickness on the surface of the silicon grains forming the sample is constant or similar.

In a second step, when a sample reaches the required density, it is isolated from the cover powder. It can either be removed from the powder mix, or the powder may be moved away from the sample, for example using a suction type method.

The sample can then be treated at high temperature, for example under a dry gas, to remove all or some of the silica remaining in the sample. The porosity and quantity of remanent silica are thus controlled.

Advantageously, the cover powder may be used to perform one of the previous methods without adding oxidising gas into the furnace chamber. It is then possible to perform one of the methods described above in furnaces in which presence of oxidising species is not perfectly controlled, or is not homogeneous around the compressed pellet.

The heat treatment steps may be done in a hermetically sealed or partially sealed chamber, preferably without any gas circulation movements, to limit cover powder loss phenomena due to the departure of SiO (see reactions 4 and 3).

A method according to the invention may include a step to remove or at least partially eliminate an oxide layer present on the surface of a sample. For example, this step may be done using a chemical treatment including HF. This step preferably precedes the step in which all or some of the silica remaining in the sample is removed, using one of the sintering methods described above.

Sintering methods at no load according to the invention also help to control the thickness of the oxide layer present on the surface and in the material during the sintering method. Controlling the thickness of the oxide layer on the silicon grains enables to control the density and porosity of the material during and after sintering.

The materials produced using this new method may be used in many applications for example such as:

making dense silicon wafers without residual oxides, for photovoltaic or thermoelectric applications,

making electrodes with controlled porosity (for batteries),

making silicon nano-crystal layers surrounded by a controlled oxide thickness of the order of one nanometer for applications in photovoltaic or light emitting fields, based on the quantum confinement effect.

Other applications are possible in the fields of optics, optoelectronics, electronics, microelectronics, etc.

1. Load-free silicon sintering method, comprising:
positioning of a silicon sample in a furnace,
heat treatment of this sample at, at least one temperature and at least one partial pressure of oxidising species to control the thickness of a silicon oxide layer on its surface.

2. Method according to claim 1, in which at least one measurement of the sample mass or at least one calculation of the sample mass is made during the sintering method.

3. Method according to claim 1, in which the thickness of the oxide layer is controlled so as to obtain a predetermined density of material.

4. Method according to claim 1, in which the thickness of the oxide layer is controlled so as to obtain a predetermined porosity of the sample.

5. Method according to claim 1, in which the thickness of the oxide layer is calculated from at least one measurement of the mass of the sample made during the sintering method.

6. Method according to claim 1, in which at least one measurement of the shrinkage of the sample is made during the sintering method.

7. Method according to claim 1, comprising a calculation of the density of the material starting from at least one measurement of the shrinkage of the material and at least one measurement of the sample mass and/or at least one calculation of the sample mass made during the sintering method.

8. Method according to claim 1, in which the sample is in the form of powder, at least before the heat treatment.

9. Method according to claim 1, in which the sample is in the form of powder, at least before the heat treatment, comprising grains having an equivalent diameter of between 500 μm and 0 nm, preferably between 5 μm and 0 nm, preferably less than 500 nm or being composed of a mix of grains with different diameters.

10. Method according to claim 1, in which the sample is in the form of powder, at least before the heat treatment, comprising grains with equivalent diameter more than 500 nm are preformed by compression of more than or equal to 900 MPa.

11. Method according to claim 1, in which the sample is in the form of powder, at least before the heat treatment, comprising grains with equivalent diameter less than 500 nm are preformed by compression of less than 600 MPa.

12. Method according to claim 1, in which the sample is in the form of powder, at least before the heat treatment, and in which the thickness of the oxide layer on the grains is preferably between 50 and 0 nm, more preferably between 20 and 0 nm, and even more preferably between 3 and 0 nm.

13. Load-free silicon sintering device, comprising:
a furnace,
means of controlling the temperature of the furnace chamber,
means of controlling the partial pressure of one or several oxidising species in the furnace,
means of controlling the temperature and partial pressure of one or several oxidising species control means in the furnace so as to control the thickness of the oxide layer on the silicon.

14. Device according to claim 13, comprising means of measuring and/or calculating the mass of the sample during sintering.

15. Device according to claim 13, comprising means of measuring and/or calculating the mass of the sample during sintering and means of calculating the thickness of an oxide layer as a function of the mass of the sample.

16. Device according to claim 13, comprising means of measuring the shrinkage of the silicon sample.

17. Device according to claim 13, comprising means of measuring the shrinkage of the silicon sample of the contact or remote type.

18. Device according to claim 13, comprising:
means of measuring and/or calculating the mass of the sample during sintering,
means of measuring the shrinkage of the sample, and
means of calculating the volume and/or density and/or porosity of the material from the mass and shrinkage of the sample.

19. Load-free silicon sintering device, comprising:
a furnace,
electrical resistances and a temperature probe designed to control the temperature of the furnace chamber,
flowmeters and a hygrometric probe designed to control the partial pressure of one or several oxidising species in the furnace,
a computer designed to control the electrical resistances and flowmeters designed to control the temperature and partial pressure of one or several oxidising species in the furnace so as to control the thickness of the oxide layer on the silicon.

20. Device according to claim 19, comprising a thermo-balance and/or a computer designed to measure and/or calculate the mass of the sample during sintering.

21. Device according to claim 19, comprising a thermo-balance designed to measure the mass of the sample during sintering and a computer designed to calculate the thickness of an oxide layer as a function of the mass of the sample.

22. Device according to claim 19, comprising a laser source and a photosensitive diode designed to measure the shrinkage of the silicon sample.

23. Device according to claim 19, comprising a feeler designed to measure the shrinkage of the silicon sample.

24. Device according to claim 19, comprising:
a thermo-balance and/or a computer designed to measure and/or calculate the mass of the sample during sintering,
a laser source and a photosensitive diode designed to measure the shrinkage of the sample, and
a computer designed to calculate the volume and/or density and/or porosity of the material from the mass and shrinkage of the sample.

25. Device according to claim 19, comprising:
a thermo-balance and/or a computer designed to measure and/or calculate the mass of the sample during sintering,
a feeler designed to measure the shrinkage of the sample, and
a computer designed to calculate the volume and/or density and/or porosity of the material from the mass and shrinkage of the sample.
